(19) United States
(12) Patent Application Publication
(10) Pub. No.: US 2012/0124867 A1
(43) Pub. Date: May 24, 2012

(54) MAGNETICALLY ALIGNED FOOTWEAR

(76) Inventor: Wilheim A. Heinrich, White Haven, PA (US)

(21) Appl. No.: 12/951,208

(22) Filed: Nov. 22, 2010

(51) Int. Cl. A43B 23/00; G09B 19/24

(52) U.S. Cl. 36/136; 434/260

(57) ABSTRACT

The present invention is directed to a pair of shoes and integral shoe alignment means comprising a first magnetic device fixed at a selected position along the instep side of a left shoe and a second magnetic device fixed to the instep side of a right shoe opposite the first magnetic device. The first magnetic device and the second magnetic device are positioned to attract and magnetically align the left shoe and the right shoe in proper position for foot placement into the magnetically aligned shoes.

### BACKGROUND

The present invention is directed to magnetic footwear suitable for use as a proper shoe alignment teaching means for young children and/or proper shoe alignment assistance for special needs persons. Correct left and right shoe alignment and placement on the user's feet is necessary for proper fit and good balance, as well as good posture and proper skeletal development in young children. Many present day footwear designs make it difficult to differentiate between the left and right shoe. This is especially true for young children who are not yet able to detect slight differences between the left and right shoe, as well as for visually impaired and other special needs persons. Past attempts to distinguish between the left and right shoe for alignment purposes include U.S. Pat. No. 5,240,418 granted to Silverman et al. on Aug. 31, 1993, where indicia on the exterior of the footwear face one another when the footwear is properly aligned, and U.S. Pat. No. 4,832,606 issued on May 23, 1989 to Clark et al. where a pair of design elements are provided within the interior of the left and right shoe to aid proper alignment. However, based on interviews we conducted with various daycare professionals, it is their consistent opinion that the above mentioned indicia or design elements are suitable as a shoe alignment teaching aid with children starting at two years of age and older. Under two years of age, most children have not yet developed cogitative skills that would allow them to understand such visual teaching aids. In addition, such visual aids have limited applicability in providing shoe alignment assistance for persons who are blind or visually impaired.

### BRIEF SUMMARY OF THE INVENTION

The present invention overcomes certain problems encountered with footwear alignment devices of the past by providing one or more magnetic portions positioned along the instep side of footwear.

In one variation of the preferred embodiment, the magnetic footwear comprises magnets fixed to corresponding shell portions along the instep side of a left shoe and a right shoe, the left shoe magnet and right shoe magnet having opposite polarity so that the left and right shoes are magnetically attracted when the shoes are properly aligned for foot placement.

In another variation of the magnetic footwear, magnets are fixed to the instep side of the left shoe and magnets are fixed to the instep side of the right shoe at locations that correspond with the left shoe instep magnets, while magnets are fixed to the out-step side of the left shoe and magnets are fixed to the out-step side of the right shoe at locations that correspond with the left shoe out-step magnets. The instep magnets are disposed to have opposite polarity between the left shoe and right shoe magnets so that the left and right shoes are magnetically attracted when the shoes are properly aligned for foot placement. The out-step side magnets are disposed to have the same polarity between the left shoe and right shoe magnets so that the left and right shoes are magnetically repel each other when the shoes are not properly aligned for foot placement.

In another variation of the magnetic footwear, magnets that emit a first audible sound when connected are fixed to corresponding shell portions along the instep side of a left and right shoe, and magnets that emit a second and different audible sound when connected are fixed to the out-step side of the left and right shoe, the first audible sound indicating when the left and right shoes are connected in proper alignment for foot placement, the second audible sound indicating when the shoes are connected improperly for foot placement.

In another variation of the magnetic footwear, magnets having opposite polarity are fixed to first corresponding shell portions along the instep side of a left and right shoe, and magnets having a reversed opposite polarity are fixed to second corresponding shell portions along the instep side of the left and right shoe so that the left and right shoes are magnetically attracted when the first corresponding shell portions and second corresponding shell portions are in proper side-by-side alignment for foot placement or storage, and so that the first corresponding shell portions magnetically repel the second corresponding shell portions when the shoes are not placed in side-by-side alignment for storage.

In another variation of the magnetic footwear, magnetic particles are contained within the plastic like resin material of a molded shoe so that the instep side of the left and right shoe are magnetically attracted when the shoes are properly aligned for foot placement.

In another variation of the magnetic footwear, magnetic devices are embedded between shell and lining along the instep portions of a left and right shoe so that the left and right shoes are magnetically attracted when properly aligned for foot placement.

As used herein, the terms “footwear” and “shoe” are used interchangeably and the terms refer to any conventional foot covering including, but not limited to, shoes, boots, sandals, slippers, and the like.

The term “young children” as used herein refers to children between the ages of 1 and 6. However, it should be understood that in certain instances, the present magnetic footwear invention may be a suitable foot placement teaching means for children under the age of one.

The term “shell” refers to the outer surface of footwear extending from the quarter, through the vamp and including the toe cap.

The term “instep” or “instep side” refers the shell portion placed adjacent the flexor hallucis longus tendon when a shoe is properly placed on a foot.

The term “out-step” or “out-step side” refers to the shell or shoe surface opposite the instep side, the out-step side placed adjacent the peroneus brevis and peroneus tertius tendons when a shoe is properly placed on a foot.

The term “magnetic-material” refers to any of the three ferromagnetic elements iron, nickel, or cobalt that are attracted to a magnet, or to any other suitable material that is readily attracted to a magnet.

The term “magnetic article” as used herein is synonymous with the word magnet.

Based on the known state of the art, past shoe alignment aids are not suitable for use with children less than two years of age and, in many instances, they provide little or no assistance for special needs persons. Most children under the age of two have not yet developed to a level that would allow them to understand the visual shoe alignment teaching aids mentioned above. Likewise, such visual shoe alignment aids have limited applicability in assisting persons who are blind or visually impaired, and other special needs persons.

Accordingly, it is a first object of the present invention to provide a simple shoe alignment teaching aid, or special needs aid that automatically aligns a left and right shoe for proper foot placement.

It is still another object of the present invention to provide a magnetic shoe nesting device whereby two or more pairs of shoes are magnetically connected or nested together to encourage good housekeeping habits in children.

Specifically, this invention comprises a pair of shoes and integral shoe alignment means including a first magnetic device fixed at a selected position along the instep side of a left shoe and a second magnetic device fixed to the instep side of a right shoe opposite the first magnetic device. The first magnetic device and the second magnetic device are positioned to attract and magnetically align the left shoe and the right shoe in proper position for foot placement into the magnetically aligned shoes.

### BRIEF DESCRIPTION OF THE DRAWINGS

FIG. 1 is a front perspective view of the preferred embodiment showing magnets fixed to the shell along the instep side of a left and right shoe.

FIG. 2 is a front perspective view of the preferred embodiment showing magnets of FIG. 1 connected to provide proper left shoe and right shoe alignment for foot placement into the shoes.

FIG. 3 is a front perspective view of the preferred embodiment showing magnets fixed to the out-step side of a left and right shoe.

FIG. 4 is a front perspective view similar to FIG. 1 showing a first set of magnets and a second set of magnets fixed to the shell along the instep side of a left and right shoe.

FIG. 5 is a side perspective view of the preferred embodiment showing a decorative ornament fixed to the surface of a magnet positioned along the instep side of a shoe.

FIG. 6 is a side perspective view of the preferred embodiment showing an alternate decorative ornament fixed to the surface of a magnet positioned along the instep side of a shoe.

FIG. 7 is a side perspective view of the preferred embodiment showing magnetic particles embedded within resin material extending along the instep side of a molded shoe.

FIG. 8 is a side elevation view showing a magnetic device embedded between the shell and lining along the instep side of a shoe.

FIG. 9 is a cross-section view taken along the lines 9-9 of FIG. 8.

### DETAILED DESCRIPTION OF THE INVENTION

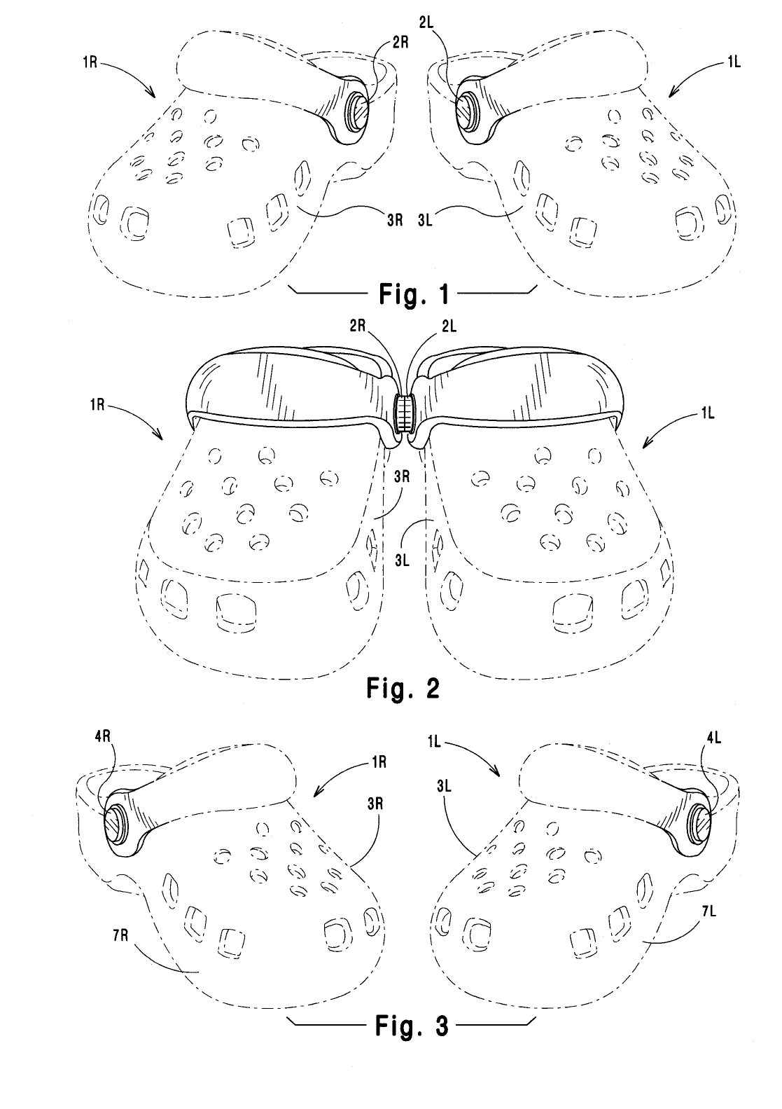

Referring to FIGS. 1 and 2 of the drawings, an exemplary pair of molded shoes, manufactured and marketed under the name CROCS™, was retrofitted to provide a prototype or early example during the development of the present magnetic shoe alignment invention. Referring specifically to FIG. 1, the exemplary footwear comprises a first or left shoe 1L and an opposite or right shoe 1R shown positioned in proper side-by-side shoe alignment for foot placement. Proper shoe alignment is not always obvious to certain children and young children frequently place their shoes on the wrong foot. This is especially true where the shape of the shoe does not have a distinctive curved appearance. Such slightly curved shoes also make it difficult for special needs persons to distinguish between a left and right shoe. To provide an improved teaching aid for children, and also to provide assistance for special needs persons, the present invention provides a pair of shoes with magnetic alignment means comprising a first magnet or magnetic article 2L fixed at a position along the instep side 3L of the left shoe 1L and a second magnet or magnetic article 2R fixed at a position along the instep side 3R of the right shoe 1R. The magnetic fields provided by magnets 2L and 2R have opposite polarity so that the shoes are attracted to each other and magnetically couple the left shoe 1L to the right shoe 1R together in proper alignment for foot placement, as illustrated in FIG. 2.

In a first alternate embodiment of the present magnetic shoe alignment invention, shown in FIG. 3, the magnetic alignment means shown in FIGS. 1 and 2 may be used in combination with a second, optional magnetic means comprising a first magnet 4L fixed at a location along the out-step side 7L of the left shoe 1L and a second magnet 4R fixed at a location along the out-step side 7R of the right shoe 1R. In one instance of the first alternate embodiment, the optional magnets 4L and 4R have opposite polarity so that they attract each other to provide means for magnetically coupling multiple pairs of such magnetic alignment shoes when stored. Such magnetically coupled strings of shoe pairs encourages children to develop good house keeping habits and assists special needs persons in locating their shoes. In such cases, where magnets 4L and 4R have opposite polarity, it may be desirable to provide a magnetic alignment means along the instep side of the shoes that emits a first audible “click” when magnets 2L and 2R are coupled, and a magnetic alignment means along the out-step side of the shoes that emits a second audible “click”, different from the first audible “click” when magnets 4L and 4R are coupled. For example, the pitch of the first audible click could be pitched above middle c and the second audible click could be pitched below middle c, the audible sounds providing an indication or signal that indicates proper or improper shoe alignment. Such pitch variations may be achieved through material selection, or through machining and/or casting techniques.

In another variation of the first alternate embodiment, the optional magnets 4L and 4R shown in FIG. 3 have the same polarity so that the left and right shoe magnets repel each other when the user improperly aligns the shoes for foot placement. Such like polarity prevents improper left right shoe alignments making it easier to teach young children proper shoe placement on their feet.

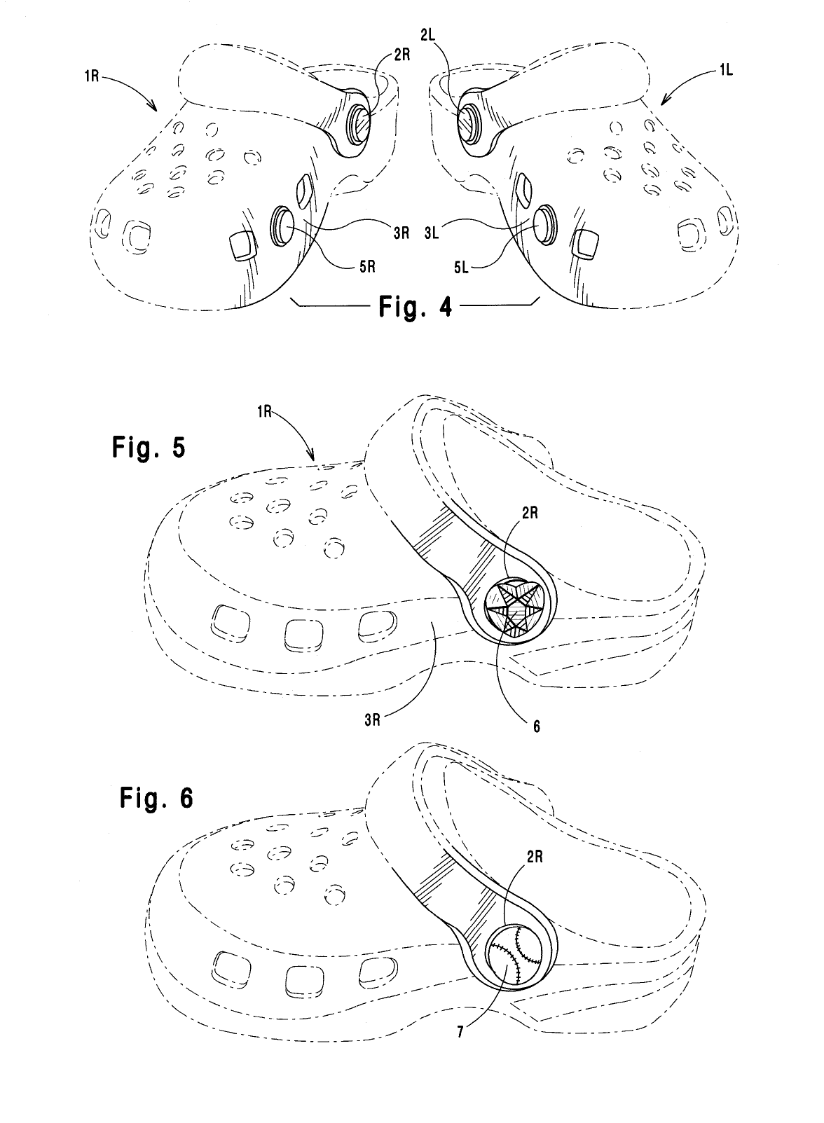

Referring to FIG. 4, showing a second alternant embodiment of the present magnetic shoe alignment invention, a first plurality of magnets, in this instance comprising a first magnet 2L fixed to the instep side 3L of the left shoe 1L, and a second magnet 5L fixed at a different location to the instep side 3L of the left shoe 1L. The first magnet 2L and second magnet 5L are disposed to provide alternating polarity to each other. For example, magnet 2L has a north/south polarity and magnet 5L has a south/north polarity. A second plurality of magnets, in this instance comprising a first magnet 2R fixed to the instep side 3R of the right shoe 1R at a location that corresponds with the position of magnet 2L, and a second magnet 5R fixed to the instep side 3R of the right shoe 1R at a location that corresponds with the position of magnet 5L. The first magnet 2R and second magnet 5R are disposed to provide alternating polarity to each other and opposite polarity with respect to their respective corresponding magnets 2L and 5L. For example, magnet 2L has a south/north polarity and magnet 5L has a north/south polarity. The alternating and opposite polarity insures that the shoes 1L and 1R are positioned heel-to-heel and toe-to-toe when magnetically aligned for proper foot placement. However, it should be understood that polarity is not limited to the above example and any number of magnets disposed to provide any combination of alternating and opposite polarity may be used without departing from the scope of the present invention. The alternating polarity between adjacent magnets on the left shoe, in combination with the alternating and opposite plurality between corresponding magnets fixed to the right shoe attracts, magnetically aligns, and couples the left shoe and right shoe in proper position for foot placement while the alternating polarity between opposing magnets repels and prevents longitudinal misalignment when the shoes are not placed heel to heel and toe to toe.

In another embodiment, shown in FIGS. 5 and 6, any of the above described magnets may be covered or trimmed with a decorative ornament to improve visual appeal and interest in the magnetic shoe alignment device. In FIG. 5 a faceted jewel like ornament 6, selected from a material that does not block or impede a magnetic field is fixed to the face of a shoe alignment magnet, for example the magnet 2R fixed to the instep side 3R of the right shoe 1R, to provide interest for girls. Referring to FIG. 6, similar to the faceted jewel like ornament 6, magnet 2R is embellished with a sports related ornament 7, in this instance a baseball, to attract and encourage boys to use the present magnetic shoe alignment device. It must be understood, however, that any suitable ornamentation, that does not block or impede a magnetic field, may be used to decorate the magnets without departing from the scope of the present invention.

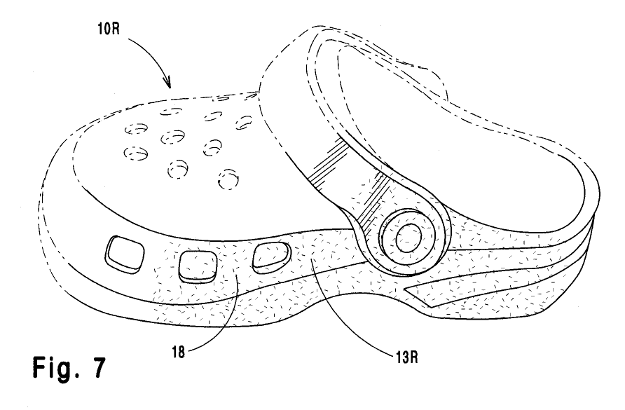

Referring to FIG. 7, showing only the right shoe member 10R to an alternate embodiment of the present magnetic shoe alignment invention, magnetic particles are combined with the resin material injected into the instep side of shoe molds so that magnetic particles 18 are entrained along the instep side 13R opposite magnetic particles entrained along the instep side of the left shoe member in a pair of finished molded shoes. The entrained magnetic particles extending along a portion of each left and right instep magnetically attract and couple the pair of shoes into proper alignment for foot placement.

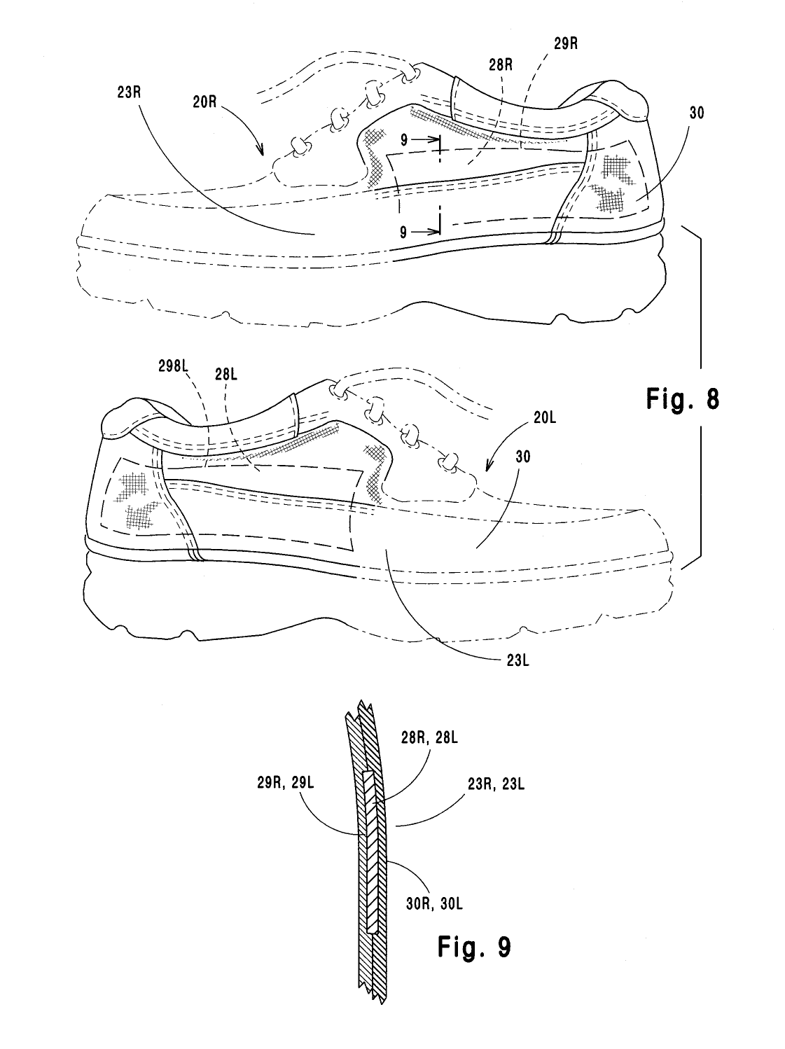

In another alternate embodiment of the present invention, shown in FIGS. 8 and 9, the first or right shoe 20R, in a pair of conventional or non-molded shoes, is shown comprising a magnetic metal plate or a flexible magnet 28R, such as a rubber or vinyl magnet or any other suitable flexible magnet 28R, inserted into a space or pocket 29R located between the shoe lining and shell 30R along the instep side 23R of the right shoe. In a similar manner, a magnetic metal plate, or a flexible magnet 28L such as a rubber or vinyl magnet or any other suitable flexible magnet 28L, is inserted into a space or pocket 29L that corresponds with pocket 29R, pocket 29L located between the shoe lining and shell 30L along the instep side 23R of the opposite or left shoe 20L. Although not shown in the drawing figures, it is understood that a plurality of spaced apart pockets and respective magnets can be provided between the shoe lining and shell along the of the instep side of the shoes without departing from the scope of the present invention. The magnets 23R and 29L are positioned to attract and magnetically align the first shoe and opposite shoe in a position for proper foot placement into the magnetically aligned shoes.

In still another alternate embodiment of the present invention, a pair of shoes shown in either FIG. 1, 4, or 8, comprises at least one magnet, for example 2R, 5R, or 28R fixed to a first or right shoe 1R, 5R, or 20R respectively and an article manufactured from magnetic-material 2L, 5L, or 28L fixed to an opposite or left shoe 1L, 5L, or 20L respectively. Similar to the above embodiments, where the first magnet attracts the opposite magnet and magnetically aligns the first shoe and opposite shoe for proper foot placement, in this embodiment, the magnet fixed to the first shoe attracts the magnetic-material article fixed to the opposite shoe and magnetically aligns the first and opposite shoes for proper foot placement into the magnetically aligned shoes.

As such, an invention has been disclosed in terms of preferred embodiments and alternate embodiments thereof, which fulfills each one of the objects of the present invention as set forth above and provides a simple shoe alignment teaching aid for children and shoe alignment assistance for special needs persons. Of course, various changes, modifications, and alterations from the teachings of the present invention may be contemplated by those skilled in the art without departing from the intended spirit and scope thereof. It is intended that the present invention only be limited by the terms of the appended claims.

1. A pair of shoes and integral shoe alignment means, comprising;
a) a first magnetic device fixed at a selected position along an instep side of a left shoe, and
b) a second magnetic device fixed to an instep side of a right shoe opposite said first magnetic device, said first magnetic device and said second magnetic device positioned to attract and magnetically align the left shoe and said right shoe in proper position for foot placement into the magnetically aligned shoes.

2. The integral shoe alignment means recited in claim 1, comprising;
a) a first instep side magnet fixed at a selected position to the instep side of the left shoe, and
b) a second instep side magnet fixed to the instep side of the right shoe at a position opposite said first instep side magnet, said first instep side magnet and said second instep side magnet positioned to attract and magnetically align the left shoe and the right shoe in proper position for foot placement into the magnetically aligned shoes.

3. The integral shoe alignment means recited in claim 2, further comprising;
a) a first out-step side magnet fixed at a selected position to the out-step side of the left shoe, and
b) a second out-step side magnet fixed to the out-step side of the right shoe at opposite said first out-step side magnet.

4. The integral shoe alignment means recited in claim 3, wherein; said first instep side magnet and said second instep side magnet emit a first audible sound when coupled together, and said first out-step side magnet and said second out-step side magnet emit a second, different audible sound when coupled together, whereby the different first emitted sound and second emitted sound indicate proper foot placement alignment and improper foot placement alignment.

5. The integral shoe alignment means recited in claim 3, wherein; said first out-step side magnet and said second out-step side magnet have a same north/south polarity to prevent improperly coupled out-step side shoe alignment.

6. The integral shoe alignment means recited in claim 2, comprising; a decorative ornament fixed to said first magnet and a decorative ornament fixed to said second magnet.

7. The integral shoe alignment means recited in claim 1, comprising
a) a magnet fixed at a selected position to the instep side of the left shoe, and
b) a magnetic-material article fixed to the instep side of the right shoe at a position opposite said first magnet so that said magnet attracts said magnetic-material article and magnetically aligns the left shoe and right shoe in proper position for foot placement into the magnetically aligned shoes.

8. The integral shoe alignment means recited in claim 7, comprising; a decorative ornament fixed to said magnet and a decorative ornament fixed to said magnetic-material article.

9. The integral shoe alignment means recited in claim 1, comprising
a) a first concentration of magnetic particles embedded within resin along an instep side of a left molded shoe, and
b) a second concentration of magnetic particles embedded within resin along an instep side of an right molded shoe opposite said first concentration of magnetic particles, said first concentration and said second concentration of magnetic particles positioned to attract and magnetically align the left molded shoe and the right molded shoe in proper position for foot placement into the magnetically aligned shoes.

10. The integral shoe alignment means recited in claim 1, comprising
a) a first magnet positioned along the instep side between a lining and shell of the left shoe, and
b) a second magnet positioned along the instep side between a lining and shell of the right shoe at a location opposite said first magnet, whereby said first magnet and said second magnet attract and magnetically align the left shoe and right shoe in proper position for foot placement into the magnetically aligned shoes.

11. The integral shoe alignment means recited in claim 1, comprising
a) a magnet positioned along the instep side between a lining and shell of the left shoe, and
b) a magnetic-material article positioned along the instep side between a lining and shell of the right shoe at a location opposite said magnet, whereby said magnet attracts said magnetic-material article and magnetically aligns the left shoe and the right shoe in proper position for foot placement into the magnetically aligned shoes.

12. A pair of shoes and integral shoe alignment means, comprising;
a) a first set of at least two magnets spaced apart and fixed to an instep side of a left shoe, and
b) a second set of at least two magnets spaced apart and fixed to an instep side of a right shoe opposite and corresponding with said set of at least two magnets, whereby said first set of at least two magnets and said second set of at least two magnets to attract and magnetically align the left shoe and the right shoe in proper position for foot placement into the magnetically aligned shoes.

13. The integral shoe alignment means recited in claim 12, wherein;
a) said first set of at least two magnets are disposed to have alternating north/south and south/north polarity between adjacent magnets in the first set of at least two magnets, and
b) said second set of at least two magnets are arranged to have alternating opposite polarity with corresponding opposite magnets in the first set of at least two magnets, whereby said alternating magnet polarity in combination with said opposite magnet polarity prevents longitudinal misalignment when the shoes are aligned for foot placement.

14. The integral shoe alignment means recited in claim 12, comprising; a decorative ornament fixed to at least one magnet in said first set of at least two magnets and a decorative ornament fixed to at least one magnet in said second set of at least two magnets.

15. A pair of shoes and integral shoe alignment means, comprising;
a) at least two magnets spaced apart and fixed to an instep side of a left shoe, and, and
b) at least two magnetic-material articles spaced apart and fixed to an instep side of a right shoe opposite said at least two magnets, whereby said magnets attract the magnetic-material articles and magnetically align the left shoe and the right shoe in proper position for foot placement into the magnetically aligned shoes.

16. The integral shoe alignment means recited in claim 15, comprising; a decorative ornament fixed to at least one magnet and a decorative ornament fixed to at least one magnetic-material article.
